(19) United States
(12) Patent Application Publication
(10) Pub. No.: US 2017/0117964 A1
(43) Pub. Date: Apr. 27, 2017

(54) Maintaining Network Connectivity During Network Upgrade

(71) Applicant: Mark F. Davis, Roswell, GA (US)

(72) Inventor: Mark F. Davis, Roswell, GA (US)

(21) Appl. No.: 15/299,789

(22) Filed: Oct. 21, 2016

Related U.S. Application Data
(60) Provisional application No. 62/245,758, filed on Oct. 23, 2015.

(51) Int. Cl. H04B 10/2575; H04B 10/25; H04B 10/27

(52) U.S. Cl. CPC H04B 10/2575; H04B 10/27; H04B 10/2503

(57) ABSTRACT

Embodiments disclosed herein include deploying a plurality of temporary pedestals at each of a plurality of termination points of an HFC network. Each temporary pedestal includes a coaxial cable interface for connecting subscribers served by the terminal point to the temporary pedestal and at least one optical fiber interface. Each temporary pedestal is communicatively coupled to an optical hub via a shared fiber or a dedicated fiber. The optical hub connects to upstream network infrastructure. At each termination point, subscribers are disconnected from an existing pedestal and connected to the temporary pedestal so that the subscribers can receive communications services via the temporary pedestal for the duration of a network upgrade.

### CROSS-REFERENCE TO RELATED APPLICATIONS

This application claims priority to U.S. Provisional Application No. 62/245,758 filed on Oct. 23, 2015, and titled “Maintaining Network Connectivity During Network Upgrade.” The entire contents of the 62/245,758 application are incorporated herein by reference for all purposes.

### SUMMARY

A network operator typically has buried conduits that are filled with existing coaxial cables via which the network operator provides telecommunications services (e.g., television, voice, data, and perhaps other communications services). As the demand for new services grows, and as the bandwidth required (or at least desired) to support new and enhanced services increases, it is often desirable to upgrade an existing coaxial cable infrastructure to an optical fiber infrastructure.

However, the cost of adding additional conduits to accommodate new fiber optic cables may be very expensive and cost prohibitive, and the trenching and other construction work required to install new conduits also often impacts customer lawns, landscaping, and perhaps other utilities. Another challenge with upgrading coaxial cable infrastructure to optical fiber infrastructure is that the subscribers who receive their communications services via the existing coaxial cable infrastructure often must go without service for hours (or perhaps even days) while the existing coaxial cable infrastructure is upgraded and/or replaced with a fiber infrastructure.

The systems and methods disclosed and described herein overcome these and other drawbacks typically associated with upgrading a coaxial cable network infrastructure to a fiber optic network infrastructure. Some embodiments include methods of maintaining network connectivity during a network upgrade and specialized equipment (e.g., temporary network pedestals) configured for use with such methods.

For example, and as described in more detail herein, some embodiments include (1) deploying one or more portable, powered (e.g., battery-powered, solar-powered, line-powered), temporary pedestals comprising one temporary pedestal at each of a corresponding one or more subscriber pedestal termination points of the HFC network, wherein the temporary pedestal at an individual subscriber pedestal termination point comprises (a) a coaxial cable interface configured to connect one or more subscribers served by the subscriber pedestal termination point to the temporary pedestal, (b) a first optical fiber interface, and (c) a second optical fiber interface; (2) connecting the one or more temporary pedestals into a daisy chain configuration; (3) communicatively coupling the daisy chain configuration of one or more temporary pedestals to an optical hub; and (4) at each subscriber pedestal termination point, (a) disconnecting one or more subscriber coaxial drop cables from an existing pedestal, and (b) connecting the one or more subscriber coaxial drop cables to the coaxial cable interface of the temporary pedestal, thereby enabling communication between the one or more subscriber coaxial drop cables (and thus, the subscribers connected thereto) and the optical hub over a single, shared temporary optical fiber connection (e.g., a single-fiber cable) via the temporary pedestal.

In another example, and as described in more detail herein, some embodiments additionally or alternatively include (1) deploying one or more portable, powered (e.g., battery, solar, or line-powered), temporary pedestals comprising one temporary pedestal at each of a corresponding one or more subscriber pedestal termination points of the HFC network, wherein the temporary pedestal at an individual subscriber pedestal termination point comprises (a) a coaxial cable interface configured to connect one or more subscribers served by the subscriber pedestal terminal point to the temporary pedestal, and (b) at least one optical fiber interface configured to connect the temporary pedestal to one fiber of a plurality of fibers in a multi-fiber cable; (2) connecting each of the one or more temporary pedestals to a different corresponding fiber of the plurality of fibers in the multi-fiber cable; (3) communicatively coupling each temporary pedestal's corresponding fiber in the multi-fiber cable to a different corresponding port of an optical hub; and (4) at each of the one or more subscriber pedestal termination points, (a) disconnecting one or more subscriber coaxial drop cables from an existing pedestal, and (b) connecting the one or more subscriber coaxial drop cables to the coaxial cable interface of the temporary pedestal, thereby enabling communication between the one or more subscriber coaxial drop cables (and thus the subscribers connected thereto) and the optical hub over the multi-fiber cable via the temporary pedestal.

Some embodiments may further comprise, at each subscriber pedestal termination point of the one or more subscriber pedestal termination points, and while the one or more subscriber coaxial drop cables are in communication with the optical hub via the temporary pedestal (over the single-fiber cable and/or the multi-fiber cable), (1) installing new pedestal hardware (2) connecting the new pedestal hardware to a new dedicated optical fiber connection to the optical hub, (3) disconnecting the one or more subscriber coaxial drop cables from the temporary pedestal, and (4) connecting the one or more subscriber coaxial drop cables to the new pedestal hardware, thereby enabling communication between the one or more subscriber coaxial drop cables (and thus the subscribers connected thereto) and the optical hub over the new dedicated optical fiber connection via the new pedestal hardware.

Some embodiments relate to the portable, powered, temporary pedestal for use in the disclosed methods of maintaining network connectivity during a network upgrade.

In some embodiments, a portable, powered, temporary pedestal comprises: (1) one or more batteries (or other powering mechanism) for powering the temporary pedestal; (2) a Radio Frequency (RF) over Glass Optical Network Unit (RFoG ONU) (or similar component configured to perform optical-to-electrical and electrical-to-optical signal conversion) comprising (a) an RFoG ONU optical port and (b) an RFoG ONU coaxial cable port connected to the coaxial cable interface of the temporary pedestal; and (3) an optical splitter/coupler (or similar component) comprising (a) a first optical port connected to the first optical fiber interface of the temporary pedestal, (b) a second optical port connected to the second optical fiber interface of the temporary pedestal, and (c) a third optical port connected to the RFoG ONU optical port.

In other example embodiments, a portable, powered, temporary pedestal comprises: (1) one or more batteries (or other powering mechanism) for powering the temporary pedestal; (2) a Radio Frequency (RF) over Glass Optical Network Unit (RFoG ONU) (or similar component configured to perform optical-to-electrical and electrical-to-optical signal conversion) comprising (a) an RFoG ONU optical port connected to one fiber of a multi-fiber cable and (b) an RFoG ONU coaxial cable port connected to the coaxial cable interface of the temporary pedestal.

In some embodiments, the temporary pedestal is configured to operate in a bidirectional fashion, wherein downstream transmissions from the optical hub to the subscriber pedestal termination point are carried on a downstream optical wavelength, and wherein upstream transmissions from the subscriber pedestal termination point to the optical hub are carried on an upstream optical wavelength that is different than the downstream optical wavelength.

Using the temporary pedestals described herein to construct and operate a temporary network to provide temporary communications services allows the network operator to upgrade the existing coaxial cable infrastructure to a higher bandwidth and more reliable fiber optic cable infrastructure, or remove the existing coaxial cable infrastructure and replace it with the higher bandwidth and more reliable fiber optic cable infrastructure. Additionally, the systems and methods disclosed herein mitigate service interruptions and/or service outages related to working on or replacing the existing coaxial cable infrastructure with the new fiber optic cable infrastructure.

### SUMMARY OF THE FIGURES

FIG. 1 shows a portion of an example network configuration of an existing hybrid fiber coaxial (HFC) cable network.

FIG. 2A shows a portion of an example temporary network configured to maintain network connectivity via a single optical fiber during a network upgrade according to some embodiments of the disclosed systems and methods.

FIG. 2B shows a portion of an example temporary network configured to maintain network connectivity via a multi-fiber cable during a network upgrade according to some embodiments of the disclosed systems and methods.

FIG. 3 shows a cross-section of a structurally-reinforced optical cable configured for use with some embodiments of the disclosed systems and methods.

FIG. 4 shows an example method of maintaining network connectivity via a single optical fiber during a network upgrade according to some embodiments of the disclosed systems and methods.

FIG. 5 shows an example method of maintaining network connectivity via a multi-fiber cable during a network upgrade according to some embodiments of the disclosed systems and methods.

### DETAILED DESCRIPTION OF THE FIGURES

The systems and methods described herein are set forth only as examples. As such, those skilled in the art will appreciate that other arrangements and elements (e.g., machines, interfaces, functions, orders, and groupings of functions) can be used instead, and that some elements or components may be omitted altogether. Further, many of the elements and components described herein are functional entities that may be implemented as discrete or distributed components or in conjunction with other elements or components, and in any suitable combination and location.

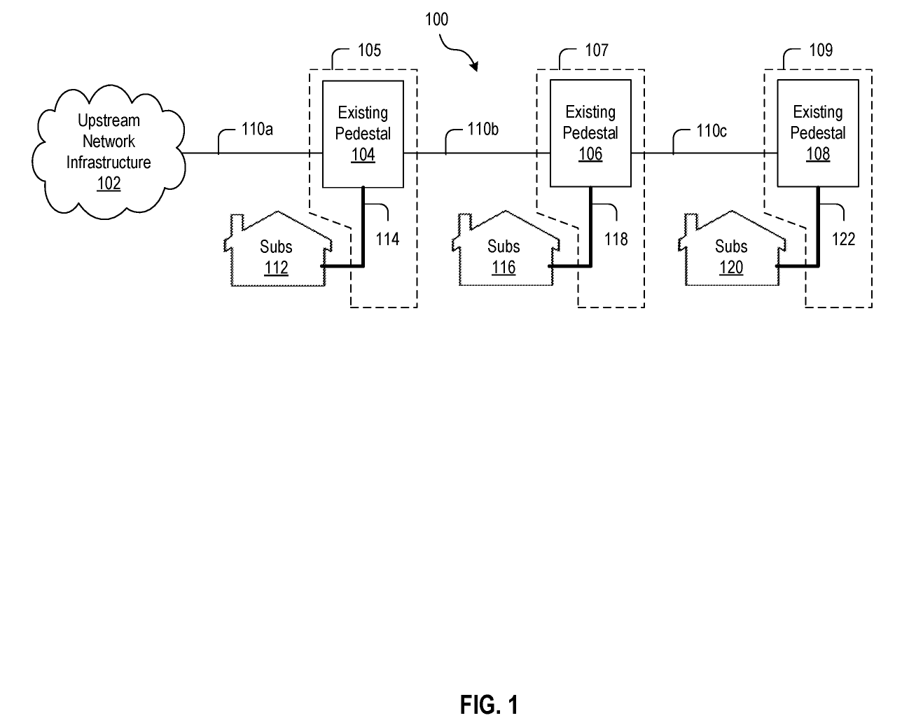

FIG. 1 shows a portion of an example network configuration of an existing hybrid fiber coaxial (HFC) cable network 100.

The portion of the existing HFC network 100 includes a plurality of existing pedestals 104, 106, and 108 located at each of a plurality of subscriber pedestal termination points 105, 107, and 109. For example, existing pedestal 104 is located at subscriber pedestal termination point 105, existing pedestal 106 is located at subscriber pedestal termination point 107, and existing pedestal 108 is located at subscriber pedestal termination point 109. The portion of the existing HFC network 100 is shown with three subscriber pedestal termination points 105, 107, and 109. But in operation, an HFC network comprising the portion shown in FIG. 1 may have many hundreds or even thousands of subscriber pedestal termination points.

In operation, the existing pedestals are connected to upstream network infrastructure 102 in a daisy-chained fashion via a coaxial cable 110, which comprises multiple spliced segments 110a, 110b, and 110c connecting the pedestals to each other and on to the upstream network infrastructure 102. For example, existing pedestal 104 is connected to the upstream network infrastructure 102 via cable segment 110a, existing pedestal 106 is connected to existing pedestal 104 via cable segment 110b, and existing pedestal 108 is connected to existing pedestal 106 via cable segment 110c.

In operation, each existing pedestal at each subscriber pedestal termination point allows one or more subscribers to connect to the HFC network. For example, subscribers 112 connect to the HFC network via access cable 114 connected to existing pedestal 104 at subscriber pedestal termination point 105, subscribers 116 connect to the HFC network via access cable 118 connected to existing pedestal 106 at subscriber pedestal termination point 107, and subscribers 120 connect to the HFC network via access cable 122 connected to existing pedestal 108 at subscriber pedestal termination point 109.

In some network implementations, the coaxial cable segments 110a, 110b, and 110c of the coaxial cable 110 may be located in a conduit buried underground, direct buried underground, hung from utility poles (or similar aerial deployment), contained within risers or conduit inside of a building, and/or any combination of the foregoing.

In some situations, it may be desirable for network operators to upgrade certain portions of an existing HFC network, such as the portion shown in FIG. 1, to a fiber-to-the-home (FTTH), fiber-to-the-curb (FTTC), fiber-to-the-distribution-point (FTTDP), or other deep fiber deployment configuration, referred to generally herein as an FTTX configuration. However, upgrading the existing coaxial cable segments 110a, 110b, and 110c to a FTTX configuration is typically a costly, disruptive, and time-consuming endeavor because of the cost and effort required to add fiber from the upstream network infrastructure 102 to the existing pedestals or perhaps all the way to individual subscriber locations. For example, adding new conduit to accommodate new fiber optic cables typically requires surveyors, engineers, technicians, and constructions crews to plan the conduit routes, trench the ground along the route, bury the new conduit, pull or blow fiber through the new conduit, and connect subscribers to the new network infrastructure.

The systems and methods disclosed and described herein reduce the time, cost, and disruption typically associated with upgrading portions of an HFC network to a FTTX configuration by using a temporary optical network to maintain service to subscribers while the existing coaxial cable portions are removed and replaced with and/or upgraded to fiber optical cable.

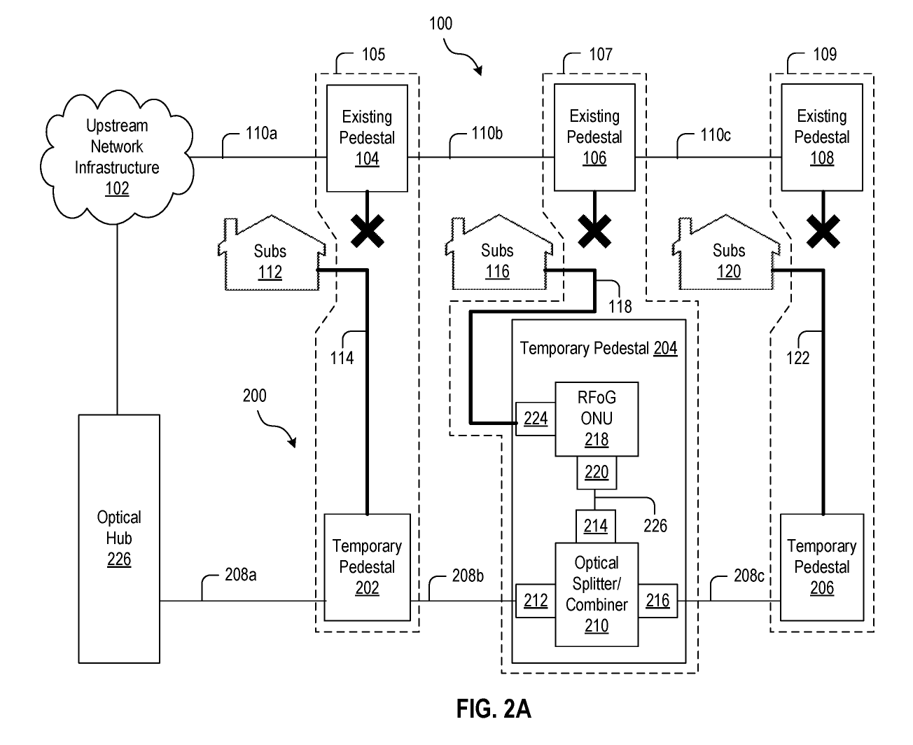

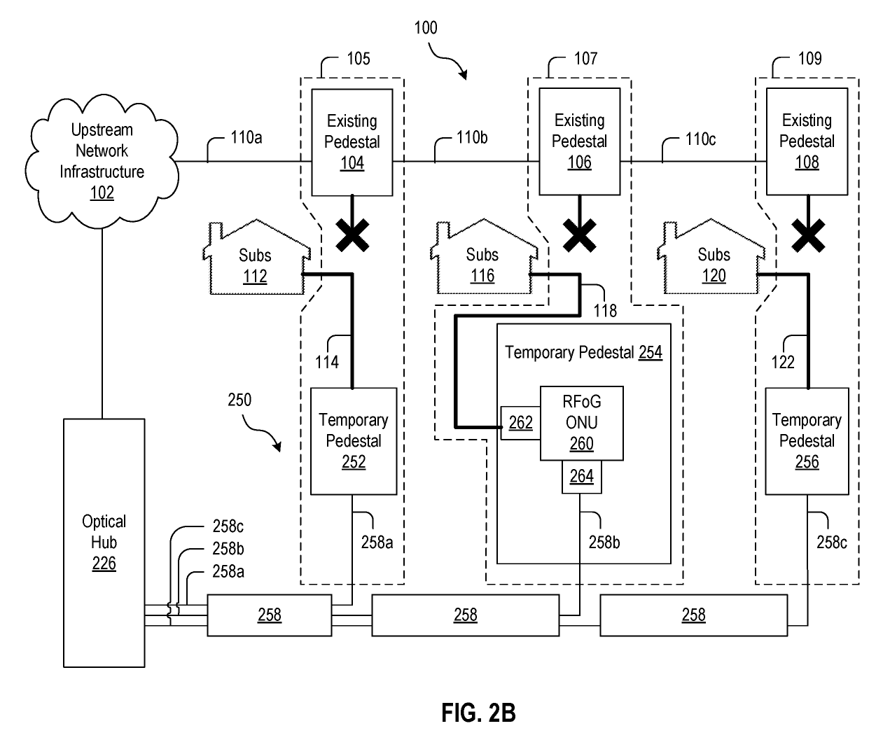

FIG. 2A shows a portion of an example temporary network 200 configured to maintain network connectivity via a single optical fiber during a network upgrade according to some embodiments of the disclosed systems and methods.

The portion of the temporary network 200 shown in FIG. 2A includes a plurality of portable, powered, temporary pedestals 202, 204, and 206 placed at each of the subscriber pedestal termination points 105, 107, and 109. For example, temporary pedestal 202 is placed at subscriber pedestal termination point 105, temporary pedestal 204 is placed at subscriber pedestal termination point 107, and temporary pedestal 206 is placed at subscriber pedestal termination point 109. The portion of the temporary network 200 is shown with temporary pedestals at three subscriber pedestal termination points 105, 107, and 109. But in operation, a temporary network according to the systems and methods disclosed herein may have more than three subscriber pedestal termination points, and perhaps up to 30, 60, or more temporary pedestals.

Temporary pedestal 204 shows a block diagram of the components of a temporary pedestal in some embodiments. In some embodiments, one or more temporary pedestals of a temporary network may have more or fewer components than the components shown in the example temporary pedestal 204 (e.g., see temporary pedestal 254 shown and described with reference to FIG. 2B). Likewise, temporary pedestals in some embodiments may have additional components not shown in the example temporary pedestal 204. Similarly, in some embodiments, some temporary pedestals in a temporary network may have a different configuration than other temporary pedestals in the temporary network. For example, in some embodiments, some temporary pedestals may have the components shown in temporary pedestal 204 (FIG. 2A) while other temporary pedestals may have the components shown in temporary pedestal 254 (FIG. 2B).

The example temporary pedestal 204 in FIG. 2A includes (i) a coaxial cable interface 224 configured to connect one or more subscribers 116 served by the subscriber pedestal terminal point 107 to the temporary pedestal 204, (ii) a first optical fiber interface 212, and (iii) a second optical fiber interface 216.

Some embodiments may also include one or more batteries (not shown) or other power source that is preferably separate from the existing HFC network 100 to power various components of the temporary pedestal 204. In other embodiments, individual temporary pedestals may be powered by a solar power source (e.g., solar panels or similar), a power line contained within or running alongside the cable segments 208a, 208b, 208c connecting the temporary pedestal to the optical hub, a temporary generator, a temporary connection to an AC power supply (e.g., a standard electrical outlet) at the subscriber pedestal termination point, or any other power source now known or later developed that would be suitable for powering the temporary pedestal on at least a temporary basis.

In operation, the temporary pedestal 204 is configured to operate in a bidirectional fashion, wherein downstream transmissions from the optical hub 226 to the subscriber pedestal termination point 107 are carried on a downstream optical wavelength, and wherein upstream transmissions from the subscriber pedestal termination point 107 to the optical hub 226 are carried on an upstream optical wavelength that is different than the downstream optical wavelength.

The example temporary pedestal 204 also includes a Radio Frequency (RF) over Glass Optical Network Unit (RFoG ONU) 218 comprising (i) an RFoG ONU optical port 220 and (ii) an RFoG ONU coaxial cable port connected to the coaxial cable interface 224 of the temporary pedestal 204. In some embodiments, the RFoG ONU coaxial cable port and the coaxial cable interface 224 of the temporary pedestal 204 may be one and the same interface. But in other embodiments, the RFoG ONU coaxial cable port may be connected to the coaxial cable interface 224 of the temporary pedestal 204 via an internal coaxial cable (not shown) running between the RFoG ONU coaxial cable port and the coaxial cable interface 224 of the temporary pedestal 204.

The example temporary pedestal 204 also includes an optical splitter/coupler 210 comprising (i) a first optical port connected to the first optical fiber interface 212 of the temporary pedestal 204, (ii) a second optical port connected to the second optical fiber interface 216 of the temporary pedestal 204, and (iii) a third optical port 214 connected to the RFoG ONU optical port 220 via an internal fiber connection 226.

In some embodiments, the first optical port of the optical splitter/coupler 210 and the first optical fiber interface 212 of the temporary pedestal 204 may be one and the same interface. But in other embodiments, the first optical port of the optical splitter/coupler 210 may be connected to the first optical fiber interface 212 of the temporary pedestal 204 via an internal fiber connection (not shown) running between the first optical port of the optical splitter/coupler 210 and the first optical fiber interface 212 of the temporary pedestal 204. Similarly, in some embodiments, the second optical port of the optical splitter/coupler 210 and the second optical fiber interface 216 of the temporary pedestal 204 may be one and the same interface. But in other embodiments, the second optical port of the optical splitter/coupler 210 may be connected to the second optical fiber interface 216 of the temporary pedestal 204 via an internal fiber connection (not shown) running between the second optical port of the optical splitter/coupler 210 and the second optical fiber interface 216 of the temporary pedestal 204.

In some embodiments, the optical splitter/coupler 210 of the temporary pedestal 204 at subscriber pedestal termination point 107 is configured to (i) pass approximately 5% of a downstream optical wavelength's signal power (received at port 212) to the third optical port 214 connected to the RFoG ONU optical port 220 via the internal fiber connection 226, (ii) pass approximately 95% of the downstream optical wavelength's signal power (received at port 212) to the second optical port of the optical splitter/coupler 210 connected to the second optical fiber interface 216 of the temporary pedestal 204, and (iii) couple upstream optical signals received at the second optical port 216 and the third optical port 214 to the first optical port 212. Such a configuration is sometimes referred to as a 5/95 split. In other embodiments, the configuration may be a 10/90 split configuration, where, for example, the optical splitter/coupler 210 passes approximately 90% of the downstream optical wavelength power from port 212 to 216 and approximately 10% of the downstream optical wavelength power from port 212 to port 214. Other embodiments may be configured for an 85/15 split configuration, where, for example, the optical splitter/coupler 210 passes approximately 85% of the downstream optical wavelength power from port 212 to 216 and approximately 15% of the downstream optical wavelength power from port 212 to port 214. Other optical splitter/coupler configurations with other split ratios are possible as well.

In some embodiments, the RFoG ONU 218 of the temporary pedestal 204 at subscriber pedestal termination point 107 may also include an optical filter (not shown) configured to separate a particular (desired) downstream optical wavelength from any other optical wavelengths received at the RFoG ONU optical port 220, or perhaps pass the desired downstream optical wavelength while blocking all other downstream wavelengths. The RFoG ONU 218 may also include (i) an optical-to-electrical converter (not shown) configured to convert optical signals on the downstream optical wavelength received (and perhaps also filtered) at port 220 to electrical signals that are output from the RFoG ONU coaxial cable port 224 to subscribers 116, and (ii) an electrical-to-optical converter (not shown) configured to convert electrical signals received at port 224 to optical signals output from the RFoG ONU optical port 220.

In some embodiments, each RFoG ONU in each temporary pedestal complies with the Society of Cable and Telecommunications Engineers standard SCTE 174 2010, the contents of which are incorporated herein by reference. Other embodiments may implement RFoG ONUs or similar active or passive optical network devices that comply with different RFoG and/or other optical networking standards and/or proprietary techniques now known or later developed. For example, in some embodiments, the temporary pedestal 204 may include an ONU that operates according to a communication protocol different than RFoG, such as Ethernet, Multimedia over Coax Alliance (MoCA), Data over Cable Service Interface Specification (DOCSIS), or other communications protocol now known or later developed. In operation, the ONU is configured to transmit upstream signals (from the ONU to the optical hub) and receive downstream signals (from the optical hub to the ONU) on a single fiber using any one or more of wavelength division multiplexing, time division multiplexing, code division multiplexing, statistical multiplexing, Ethernet, MoCA, DOSCIS, or any other type of shared media access technique now known or later developed.

Such ONUs are preferably (but not necessarily) configured to at least (i) receive downstream digital and/or analog optical signals from the optical hub, convert the received downstream digital and/or analog optical signals to downstream digital and/or analog electrical signals, and transmit the converted downstream digital and/or analog electrical signals to subscriber equipment and (ii) receive upstream digital and/or analog electrical signals from subscriber equipment, convert the received upstream digital and/or analog electrical signals to digital and/or analog upstream optical signals, and transmit the converted digital and/or analog upstream optical signals to the optical hub.

In some embodiments, the ONU may additionally perform communication protocol conversions between the optical and electrical signals to facilitate and/or enable communication between subscriber equipment and the upstream network infrastructure 102 via the temporary connection between the temporary pedestal and the optical hub 226.

After the plurality of temporary pedestals 202, 204, and 206 have been placed at each of the subscriber pedestal termination points 105, 107, and 109 for the temporary network 200, the plurality of temporary pedestals 202, 204, and 206 are connected in a daisy chain configuration.

In operation, connecting the plurality of temporary pedestals 202, 204, and 206 into the daisy chain configuration comprises, for one temporary pedestal at one subscriber pedestal termination point: (i) connecting the first optical fiber interface of the one temporary pedestal to one fiber of a first structurally-reinforced temporary optical cable (e.g., a single or multi-fiber cable) running over ground between the one subscriber pedestal termination point and a first adjacent subscriber pedestal termination point; and (ii) connecting the second optical fiber interface of the one temporary pedestal to one fiber of a second structurally-reinforced temporary optical cable (e.g., a single or multi-fiber cable) running over ground between the one subscriber pedestal termination point and a second adjacent subscriber pedestal termination point.

For example, at temporary pedestal 204 at subscriber pedestal termination point 107, (i) optical port 212 of temporary pedestal 204 is connected to one fiber of structurally-reinforced temporary optical cable 208b running over ground between the subscriber pedestal termination point 107 and subscriber pedestal termination point 105, and (ii) optical port 216 of temporary pedestal 204 is connected to one fiber of structurally-reinforced temporary optical cable 208c running over ground between the subscriber pedestal termination point 107 and subscriber pedestal termination point 109. In a similar fashion, temporary pedestal 206 would be connected to adjacent downstream temporary pedestal (not shown) via another single fiber of a structurally-reinforced optical cable (not shown) running over ground between subscriber pedestal termination point 109 and an adjacent downstream subscriber pedestal termination point (not shown) where the downstream temporary pedestal (not shown) has been placed.

In operation, the structurally-reinforced optical cable comprises at least one optical fiber and one or more fiberglass components (or other sufficiently strong but flexible reinforcement components) arranged in a manner to protect the optical fiber from damage while the optical cable lays along the ground between subscriber pedestal termination points.

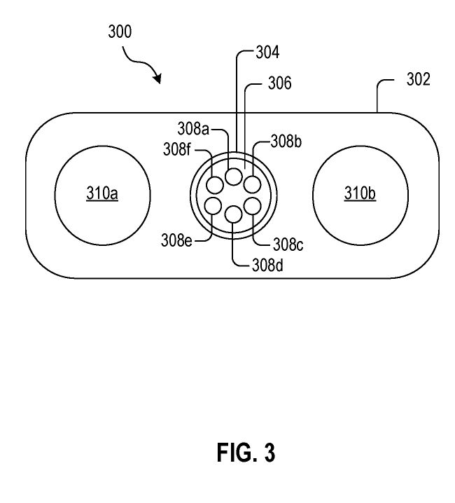

For example, FIG. 3 shows a cross-section of an example structurally-reinforced optical cable 300 configured for use with some embodiments of the disclosed systems and methods.

Structurally-reinforced optical cable 300 includes an outer protective jacket 302 enclosing an inner buffer tube 304 and two structural support members 310a and 310b. The inner buffer tube 304 is filled with gel 306 that surrounds a plurality of individual optical fibers 308a-308f. Although cable 300 shows six individual optical fibers 308a-308f, in practice, the systems and methods disclosed herein can operate with cables having fewer (as little as one) or more individual optical fibers. In some embodiments, the structural support members 310a and 310b are fiberglass or some other sufficiently strong but sufficiently flexible material suitable for reinforcing the cable 300 and protecting the fibers 308a-308f within buffer tube 304 from damage. Although cable 300 shows two structural support members 310a and 310b, in practice, the systems and methods disclosed herein can operate with cables having different arrangements of fewer or more structural members or perhaps with different structural reinforcement mechanisms than the ones shown in cable 300.

It is typically not desirable to connect network equipment (such as pedestals) with optical fiber that is laid along the ground (even optical fiber within a structurally-reinforced optical cable) because optical fiber is fragile and can be damaged or even destroyed when people walk or vehicles drive over the optical fiber cable, or it can be accidentally disconnected from network devices such as the temporary pedestals. Rather than being laid along the ground, optical fiber cables (even structurally-reinforced optical cables) are typically buried under the ground (direct buried or in protective conduits) or hung from utility poles so that they are protected from damage. But because the optical fiber cable used in the embodiments disclosed herein is structurally reinforced and is only used for a short period of time (e.g., typically a few hours or days and preferably less than about a month) while network upgrades are performed, the risk of damage to the optical fiber (and the resulting network service outage) can be reduced substantially.

Connecting the temporary pedestals with the temporary, structurally-reinforced optical cable has many advantages over prior art procedures. For example, the temporary, structurally-reinforced optical cable is more affordable (typically on the order of a few cents per foot), has a smaller form factor (having a cross-section typically on the order of about 10 mm wide and 5 mm tall), and is lightweight and easy for technicians to work with as compared to temporary coaxial cable used in prior art procedures. In comparison to the temporary, structurally-reinforced optical cable used in the disclosed systems and methods, prior art coax cabling is larger, more easily damaged and/or crushed by cars and/or pedestrian traffic, and requires large, power-hungry coax amplifiers every approximately 1000 feet.

Returning to FIG. 2A, after the plurality of temporary pedestals have been connected together in a daisy chain configuration, the daisy chain configuration of temporary pedestals is connected to an optical hub 226 that is connected to the upstream network infrastructure 102. Once the daisy chain configuration of temporary pedestals is connected to the optical hub 226, all of the temporary pedestals are communicatively coupled to one single optical port on the optical hub 226 via a single, shared temporary optical fiber connection 208 comprising temporary optical fiber segments 208a, 208b, and 208c.

Next, at each subscriber pedestal termination point, (i) one or more subscriber coaxial drop cables are disconnected from the existing pedestal, and (ii) the one or more subscriber coaxial drop cables are connected to the coaxial cable interface of the temporary pedestal, thereby enabling communication between the one or more subscriber coaxial drop cables (and the subscribers connected thereto) and the optical hub over a single, shared temporary optical fiber connection via the temporary pedestal. For example, at subscriber pedestal termination point 105, the one or more coaxial drop cables 114 are disconnected from existing pedestal 104 and connected to temporary pedestal 202. Similarly, at subscriber pedestal termination point 107, the one or more coaxial drop cables 118 are disconnected from existing pedestal 106 and connected to temporary pedestal 204. And at subscriber pedestal termination point 109, the one or more coaxial drop cables 122 are disconnected from existing pedestal 108 and connected to temporary pedestal 206.

After the subscriber coaxial drop cables are disconnected from the existing pedestals and connected to the temporary pedestals, the subscribers 112, 116, and 120 connected to the temporary pedestals 202, 204, and 206 are able to communicate with the upstream network infrastructure 102 over the temporary network 200 (i.e., via the temporary pedestals 202, 204, and 206 and the optical hub 226 via the shared, single optical fiber connection 208 (comprised of segments 208a, 208b, and 208c)). After the subscribers 112, 116, and 120 are in communication with the upstream network infrastructure 102 over the temporary network 200, the existing network cable (i.e., cable 110 comprising segments 110a, 110b, and 110c) and/or the existing pedestals 104, 106, and 108 can be upgraded. In operation, the subscribers 112, 116, and 120 continue to receive network service over the temporary network 200 while the work to upgrade the existing network is performed.

After the subscribers 112, 116, and 120 are in communication with the upstream network infrastructure 102 over the temporary network 200, the existing network can be upgraded. In operation, the network upgrade may include, at each subscriber pedestal termination point, and while the one or more subscriber coaxial drop cables are in communication with the optical hub over the single, shared temporary optical fiber connection via the temporary pedestal, (i) installing new pedestal hardware, (ii) connecting the new pedestal hardware to a new dedicated optical fiber connection to the optical hub (or perhaps another optical network device), (iii) disconnecting the one or more subscriber coaxial drop cables from the temporary pedestal, and (iv) connecting the one or more subscriber coaxial drop cables to the new pedestal hardware, thereby enabling communication between the one or more subscriber coaxial drop cables and the optical hub over the new dedicated optical fiber connection via the new pedestal hardware.

For example, with reference to FIG. 2A, the network upgrade may include replacing the existing coaxial cabling 110 (including segments 110a, 110b, and 110c) with optical cabling. The new optical cabling (not shown) may include a single optical fiber connection from each existing pedestal to the upstream network infrastructure 102 and/or perhaps the optical hub 226. In some embodiments, replacing the existing coaxial cabling 110 with new optical cabling may be accomplished according to any of many different cable replacement/upgrade techniques now known or later developed. The network upgrade may also include replacing the existing pedestals 104, 106, and 108 with new pedestal hardware, which may include wholly new pedestals, or perhaps new equipment installed in the existing pedestals. But because the subscribers are receiving service via the temporary network 200 during the network upgrade, the network upgrade activities can proceed with little to no impact on the network services received by the sub scribers.

Typically, in a dense urban or suburban type area, it is sometimes undesirable for multiple pedestals to be connected to a single port of an optical hub via a single, shared optical fiber connection because as the number of pedestals on a single, shared optical fiber connection increases, contention for use of the connection between the multiple subscribers served via the pedestals connected to that single port on the optical hub tends to increase, which can reduce the effective transmission speeds that can be obtained by the individual subscribers served via the pedestals connected to that single port on the optical hub. Rather than having multiple pedestals connected to a single port of an optical hub via a single shared optical fiber connection, network operators typically prefer a network configuration where each pedestal is connected to its own port on the optical hub via a dedicated fiber between the optical hub and the pedestal. Although this arrangement results in more fibers deployed in the network, it results in less contention between subscribers for use of the network in the portion of the network between the optical hub and the pedestals.

FIG. 2B shows a portion of an example temporary network 250 configured to maintain network connectivity via a multi-fiber cable during a network upgrade according to some embodiments of the disclosed systems and methods. One of the main differences between temporary network 200 shown in FIG. 2A and temporary network 250 shown in FIG. 2B is that temporary pedestals 202, 204, and 206 in temporary network 200 are connected to a single port of optical hub 226 in a daisy-chained fashion via a single, shared optical fiber connection comprising segments 208a, 208b, and 208c, whereas temporary pedestals 252, 254, and 256 in temporary network 250 are each connected to a separate optical port of optical hub 226 over respective optical fibers 258a, 258b, and 258c of multi-fiber cable 258, as described in more detail herein. In some embodiments, the multi-fiber cable 258 is similar to optical cable 300 (and variants thereof) shown and described with reference to FIG. 3. Differences in the configurations of temporary pedestal 204 (FIG. 2A) and temporary pedestal 254 (FIG. 2B) are based at least in part on the differences between the daisy chain configuration of temporary network 200 and the dedicated fiber configuration of temporary network 250.

Similar to the portion of the temporary network 200 shown in FIG. 2A, the portion of the temporary network 250 shown in FIG. 2B includes a plurality of portable, powered, temporary pedestals 252, 254, and 256 placed at each of the subscriber pedestal termination points 105, 107, and 109. For example, temporary pedestal 252 is placed at subscriber pedestal termination point 105, temporary pedestal 254 is placed at subscriber pedestal termination point 107, and temporary pedestal 256 is placed at subscriber pedestal termination point 109. The portion of the temporary network 250 is shown with temporary pedestals at three subscriber pedestal termination points 105, 107, and 109. But in operation, a temporary network according to the systems and methods disclosed herein may have more than three subscriber pedestal termination points, and perhaps up to 30, 60, or more temporary pedestals.

Temporary pedestal 254 shows a block diagram of the components of a temporary pedestal in some embodiments. In some embodiments, one or more temporary pedestals of a temporary network may have more or fewer components than the components shown in the example temporary pedestal 254 (e.g., see temporary pedestal 204 shown and described with reference to FIG. 2A). Likewise, temporary pedestals in some embodiments may have additional components not shown in the example temporary pedestal 254. Similarly, in some embodiments, some temporary pedestals in a temporary network may have a different configuration than other temporary pedestals in the temporary network. For example, in some embodiments, some temporary pedestals may have the components shown in temporary pedestal 204 (FIG. 2A) while other temporary pedestals may have the components shown in temporary pedestal 254 (FIG. 2B).

The example temporary pedestal 254 in FIG. 2B includes (i) a coaxial cable interface 262 configured to connect one or more subscribers 116 served by the subscriber pedestal terminal point 107 to the temporary pedestal 254, and (ii) an optical fiber interface 264 configured to connect the temporary pedestal 254 to one fiber 258b of multi-fiber cable 258.

Some embodiments may also include one or more batteries (not shown) or other power source that is preferably separate from the existing HFC network 100 to power various components of the temporary pedestal 254. In other embodiments, and similar to pedestal 204 (FIG. 2A), individual temporary pedestals may be powered by a solar power source (e.g., solar panels or similar), a power line contained within or running alongside cable 208 connecting the temporary pedestal to the optical hub, a temporary generator, a temporary connection to an AC power supply (e.g., a standard electrical outlet) at a temporary pedestal, or any other power source now known or later developed that would be suitable for powering the temporary pedestal on at least a temporary basis.

In operation, the temporary pedestal 254 is configured to operate in a bidirectional fashion, where downstream transmissions from the optical hub 226 to the subscriber pedestal termination point 107 are carried on a downstream optical wavelength, and upstream transmissions from the subscriber pedestal termination point 107 to the optical hub 226 are carried on an upstream optical wavelength that is different than the downstream optical wavelength.

The example temporary pedestal 254 also includes a Radio Frequency (RF) over Glass Optical Network Unit (RFoG ONU) 260. The RFoG ONU 260 may be similar to or the same as RFoG ONU 218 (FIG. 2A). RFoG ONU 260 comprises (i) an RFoG ONU optical port connected to the optical fiber interface 264 of the temporary pedestal 254 and (ii) an RFoG ONU coaxial cable port connected to the coaxial cable interface 262 of the temporary pedestal 254.

In some embodiments, the RFoG ONU coaxial cable port and the coaxial cable interface 262 of the temporary pedestal 254 may be one and the same interface. But in other embodiments, the RFoG ONU coaxial cable port may be connected to the coaxial cable interface 262 of the temporary pedestal 254 via an internal coaxial cable (not shown) running between the RFoG ONU coaxial cable port and the coaxial cable interface 262 of the temporary pedestal 254. Similarly, in some embodiments, the RFoG ONU optical port and the optical fiber interface 264 of the temporary pedestal 254 may be one and the same interface. But in other embodiments, the RFoG ONU optical port may be connected to the optical fiber interface 264 of the temporary pedestal 254 via an internal fiber cable (not shown) running between the RFoG ONU optical port and the optical fiber interface 264 of the temporary pedestal 254.

In some embodiments, the RFoG ONU 260 of the temporary pedestal 254 at subscriber pedestal termination point 107 may also include an optical filter (not shown) configured to separate a particular (desired) downstream optical wavelength from any other optical wavelengths received by the optical fiber interface 264, or perhaps pass the desired downstream optical wavelength while blocking all other downstream wavelengths. The RFoG ONU 260 may also include (i) an optical-to-electrical converter (not shown) configured to convert optical signals on the downstream optical wavelength received (and perhaps also filtered) at port 264 to electrical signals that are output from port 224 to subscribers 116, and (ii) an electrical-to-optical converter (not shown) configured to convert electrical signals received at port 262 to optical signals output from port 264.

In some embodiments, each RFoG ONU in each temporary pedestal 254 complies with the Society of Cable and Telecommunications Engineers standard SCTE 174 2010. Other embodiments may implement RFoG ONUs or similar active or passive optical network devices that comply with different RFoG and/or other optical networking standards and/or proprietary techniques now known or later developed.

For example, in some embodiments, and like temporary pedestal 204 (FIG. 2A), the temporary pedestal 254 may include an ONU that operates according to a communication protocol different than RFoG, such as Ethernet, Multimedia over Coax Alliance (MoCA), Data over Cable Service Interface Specification (DOCSIS), or other communications protocol now known or later developed. In operation, the ONU is configured to transmit upstream signals (from the ONU to the optical hub) and receive downstream signals (from the optical hub to the ONU) on a single fiber using any one or more of wavelength division multiplexing, time division multiplexing, code division multiplexing, statistical multiplexing, Ethernet, MoCA, DOSCIS, or any other type of shared media access technique now known or later developed.

Such ONUS are preferably (but not necessarily) configured to at least (i) receive downstream digital and/or analog optical signals from the optical hub, convert the received downstream digital and/or analog optical signals to downstream digital and/or analog electrical signals, and transmit the converted digital and/or analog electrical signals to subscriber equipment and (ii) receive upstream digital and/or analog electrical signals from subscriber equipment, convert the received digital and/or analog electrical signals to digital and/or analog optical signals, and transmit the converted digital and/or analog optical signals to the optical hub.

In some embodiments, the ONU may additionally perform communication protocol conversions between the optical and electrical signals to facilitate and/or enable communication between subscriber equipment and the upstream network infrastructure 102 via the temporary connection between the temporary pedestal and the optical hub 226.

After the plurality of portable, powered, temporary pedestals 252, 254, and 256 have been placed at each of the subscriber pedestal termination points 105, 107, and 109 for the temporary network 250, each temporary pedestal is connected to optical hub 226 via a single, dedicated fiber of a multi-fiber cable. For example, temporary pedestal 252 is connected to a first port of the optical hub via dedicated fiber 258c, temporary pedestal 254 is connected to a second port of the optical hub via dedicated fiber 258b, and temporary pedestal 256 is connected to a third port of optical hub 226 via dedicated fiber 258c.

In operation, fibers 258a, 258b, and 258c are enclosed within a structurally-reinforced multi-fiber cable. The structurally-reinforced multi-fiber cable comprises at least a plurality of optical fibers (e.g., 8, 12, 24, 48, or more fibers) and one or more fiberglass components (or other sufficiently strong but flexible reinforcement components) arranged in a manner to protect the optical fibers from damage while the multi-fiber cable lays along the ground providing network connectivity to the subscriber pedestal termination points. As mentioned above, in some embodiments, the structurally-reinforced multi-fiber cable may be similar to or the same as cable 300 (and variants thereof) shown and described with reference to FIG. 3.

In some embodiments, the multi-fiber cable is custom-fabricated before temporary network 250 is deployed. For example, if the temporary network 250 is to be deployed in a neighborhood where each subscriber pedestal termination point is 100 feet from each other (e.g., because each lot in the neighborhood is 100 feet wide), then the multi-fiber cable 258 can be fabricated ahead of time with individual optical fiber cable jumpers extending from the multi-fiber cable 258 every approximately 100 feet. In other embodiments, individual fibers in the multi-fiber cable 258 can be accessed in the field as needed, and optical fiber cable jumpers can be spliced or otherwise connected to the individual fibers of the multi-fiber cable 258. In FIG. 2B, cables 258a, 258b, and 258c include such optical fiber cable jumpers extending from the multi-fiber cable 258 to each of the temporary pedestals 252, 254, and 256.

As mentioned above, it is typically not desirable to connect network equipment (such as pedestals) with optical fiber that is laid along the ground (even optical fibers within a structurally-reinforced optical fiber cable) because optical fiber is fragile and can be damaged or even destroyed when people walk or vehicles drive over the optical fiber cable, or it can be accidentally disconnected from network devices such as the temporary pedestals. This is particularly true for high fiber count multi-fiber cables because of the added expense to deploy (and if necessary, repair) high fiber count multi-fiber cables. Rather than being laid along the ground, multi-fiber cables (even structurally-reinforced multi-fiber cables) are typically buried under the ground (direct buried or in protective conduits) or hung from utility poles so that they are protected from damage. But because the multi-fiber cable used in the embodiments disclosed herein is structurally reinforced and is only used for a short period of time (e.g., typically a few hours or days and preferably less than about a month) while network upgrades are performed, the risk of damage to the multi-fiber (and the resulting network service outage) can be reduced.

However, connecting the temporary pedestals with the temporary, structurally-reinforced multi-fiber optical cable 258 has many advantages over prior art procedures. For example, the temporary, structurally-reinforced multi-fiber optical cable 258 is more affordable (typically on the order of a few cents or more per foot, depending on the number of fibers), has a smaller form factor (typically having a cross-section on the order of about 10 mm wide and 5 mm tall, or slightly larger depending on the number of fibers), and is lightweight and easy for technicians to work with as compared to temporary coaxial cable used in prior art procedures. In comparison to the temporary, structurally-reinforced multi-fiber optical cable used in the disclosed systems and methods, prior art coax cabling is larger, more easily damaged and/or crushed by cars and/or pedestrian traffic, and requires large, power-hungry coax amplifiers every approximately 1000 feet.

Once each temporary pedestal 252, 254, and 256 is connected to a dedicated port of optical hub 226 via its own dedicated fiber (i.e., 258a, 258b, and 258c) of the multi-fiber cable 258, each of the temporary pedestals 252, 254, and 256 can communicate with network infrastructure 102 via optical hub 226.

Next, at each subscriber pedestal termination point, (i) one or more subscriber coaxial drop cables are disconnected from the existing pedestal, and (ii) the one or more subscriber coaxial drop cables are connected to the coaxial cable interface of the temporary pedestal, thereby enabling communication between the one or more subscriber coaxial drop cables (and the subscribers connected thereto) and the optical hub 226 over the multi-fiber cable 258. For example, at subscriber pedestal termination point 105, the one or more coaxial drop cables 114 are disconnected from existing pedestal 104 and connected to temporary pedestal 252. Similarly, at subscriber pedestal termination point 107, the one or more coaxial drop cables 118 are disconnected from existing pedestal 106 and connected to temporary pedestal 254. And at subscriber pedestal termination point 109, the one or more coaxial drop cables 122 are disconnected from existing pedestal 108 and connected to temporary pedestal 256.

After the subscriber coaxial drop cables are disconnected from the existing pedestals and connected to the temporary pedestals, the subscribers 112, 116, and 120 connected to the temporary pedestals 252, 254, and 256 are able to communicate with the upstream network infrastructure 102 over the temporary network 250 (i.e., via the temporary pedestals 252, 254, and 256 and the optical hub 226 via the multi-fiber cable 258 (comprised of fibers 258a, 258b, and 258c)). After the subscribers 112, 116, and 120 are in communication with the upstream network infrastructure 102 over the temporary network 250, the existing network cable (i.e., cable 110 comprising segments 110a, 110b, and 110c) and/or the existing pedestals 104, 106, and 108 can be upgraded. In operation, the subscribers 112, 116, and 120 continue to receive network service over the temporary network 250 while the work to upgrade the existing network is performed.

After the subscribers 112, 116, and 120 are in communication with the upstream network infrastructure 102 over the temporary network 250, the existing network can be upgraded. In operation, the network upgrade may include, at each subscriber pedestal termination point, and while the one or more subscriber coaxial drop cables are in communication with the optical hub over the multi-fiber cable via the temporary pedestal, (i) installing new pedestal hardware, (ii) connecting the new pedestal hardware to a new dedicated optical fiber connection to the optical hub, (iii) disconnecting the one or more subscriber coaxial drop cables from the temporary pedestal, and (iv) connecting the one or more subscriber coaxial drop cables to the new pedestal hardware, thereby enabling communication between the one or more subscriber coaxial drop cables and the optical hub over the new dedicated optical fiber connection via the new pedestal hardware.

For example, with reference to FIG. 2B, the network upgrade may include replacing the existing coaxial cabling 110 (including segments 110a, 110b, and 110c) with optical cabling. The new optical cabling (not shown) may include a single optical fiber connection from each existing pedestal to the upstream network infrastructure 102 and/or perhaps the optical hub 226. In some embodiments, replacing the existing coaxial cabling 110 with new optical cabling may be accomplished according to any of many different cable replacement/upgrade techniques now known or later developed. The network upgrade may also include replacing the existing pedestals 104, 106, and 108 with new pedestal hardware, which may include wholly new pedestals, or perhaps new equipment installed in the existing pedestals. But because the subscribers are receiving service via the temporary network 250 during the network upgrade, the network upgrade activities can proceed with little to no impact on the network services received by the sub scribers.

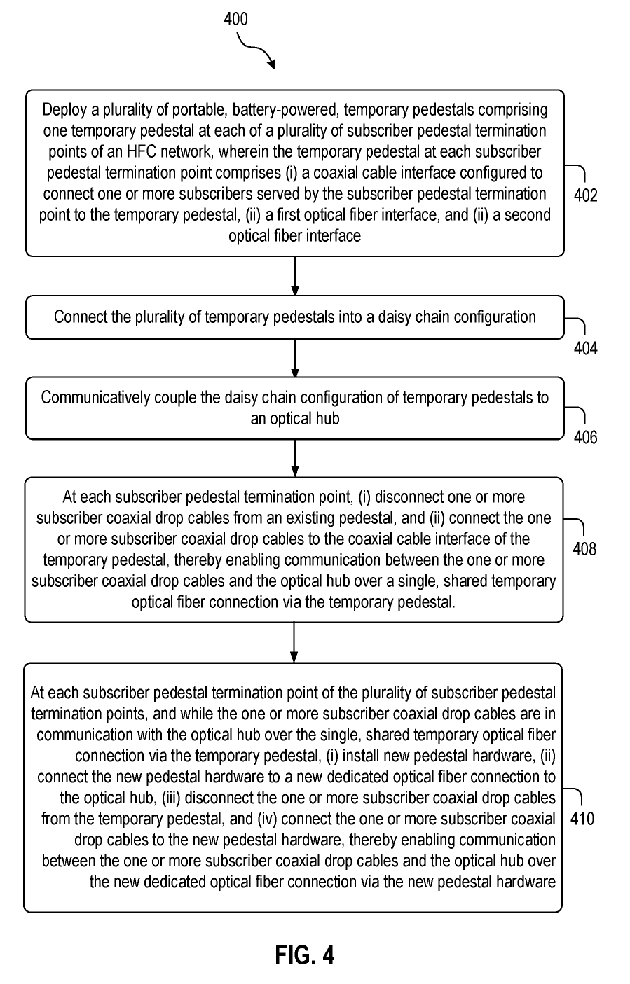

FIG. 4 shows an example method 400 of maintaining network connectivity via a single optical fiber during a network upgrade according to some embodiments of the disclosed systems and methods.

Method 400 begins at block 402, which includes deploying a plurality of portable, battery-powered (or other-powered, as described herein), temporary pedestals comprising one temporary pedestal at each of a plurality of subscriber pedestal termination points of an HFC network, wherein the temporary pedestal at each subscriber pedestal termination point comprises (i) a coaxial cable interface configured to connect one or more subscribers served by the subscriber pedestal termination point to the temporary pedestal, (ii) a first optical fiber interface, and (ii) a second optical fiber interface. In some embodiments, the temporary pedestal may be the same as or similar to temporary pedestal 204 (and variants thereof) shown and described with reference to FIG. 2A.

Next, method 400 proceeds to block 404, which includes connecting the plurality of temporary pedestals into a daisy chain configuration. In some embodiments, connecting the plurality of temporary pedestals into the daisy chain configuration comprises, for one temporary pedestal at one subscriber pedestal termination point: (i) connecting the first optical fiber interface of the one temporary pedestal to a first structurally-reinforced temporary optical cable running over ground between the one subscriber pedestal termination point and a first adjacent subscriber pedestal termination point; and (ii) connecting the second optical fiber interface of the one temporary pedestal to a second structurally-reinforced temporary optical cable running over ground between the one subscriber pedestal termination point and a second adjacent subscriber pedestal termination point. In operation, the structurally-reinforced cable may be the same as or similar to the structurally-reinforced cable 208 (comprised of segments 208a, 208b, and 208c) or structurally-reinforced cable 300 shown and described with reference to FIGS. 2A and 3, respectively.

Next, method 400 proceeds to block 406, which includes communicatively coupling the daisy chain configuration of temporary pedestals to an optical hub.

Next, method 400 proceeds to block 408, which includes, at each subscriber pedestal termination point, (i) disconnecting one or more subscriber coaxial drop cables from an existing pedestal, and (ii) connecting the one or more subscriber coaxial drop cables to the coaxial cable interface of the temporary pedestal, thereby enabling communication between the one or more subscriber coaxial drop cables and the optical hub over a single, shared temporary optical fiber connection via the temporary pedestal. In operation, after connecting the plurality of temporary pedestals into a daisy chain configuration and communicatively coupling the daisy chain configuration of temporary pedestals to the optical hub, all of the temporary pedestals of the plurality of temporary pedestals are configured to communicate with the optical hub over a single, shared optical fiber. In some embodiments, the network configuration after connecting the plurality of temporary pedestals into a daisy chain configuration and communicatively coupling the daisy chain configuration of temporary pedestals to the optical hub is the same as or similar to the network configuration of the temporary network shown and described with reference to FIG. 2A.

Then, method 400 proceeds to block 410, which includes, at each subscriber pedestal termination point of the plurality of subscriber pedestal termination points, and while the one or more subscriber coaxial drop cables are in communication with the optical hub over the single, shared temporary optical fiber connection via the temporary pedestal, (i) installing new pedestal hardware (ii) connecting the new pedestal hardware to a new dedicated optical fiber connection to the optical hub, (iii) disconnecting the one or more subscriber coaxial drop cables from the temporary pedestal, and (iv) connecting the one or more subscriber coaxial drop cables to the new pedestal hardware, thereby enabling communication between the one or more subscriber coaxial drop cables and the optical hub over the new dedicated optical fiber connection via the new pedestal hardware.

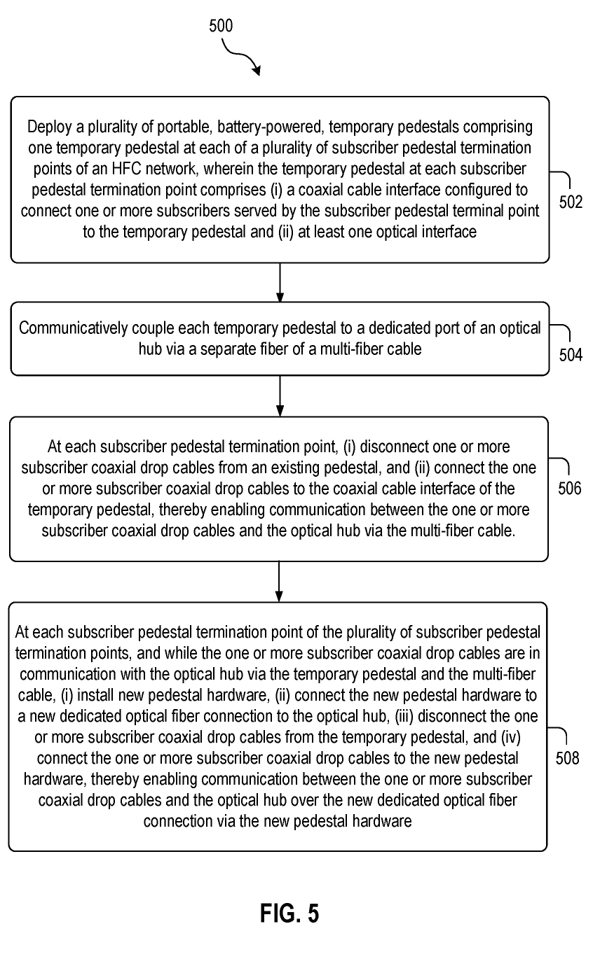

FIG. 5 shows an example method 500 of maintaining network connectivity via a multi-fiber cable during a network upgrade according to some embodiments of the disclosed systems and methods.

Method 500 begins at block 502, which includes deploying a plurality of portable, battery-powered, temporary pedestals comprising one temporary pedestal at each of a plurality of subscriber pedestal termination points of an HFC network, wherein the temporary pedestal at each subscriber pedestal termination point comprises (i) a coaxial cable interface configured to connect one or more subscribers served by the subscriber pedestal terminal point to the temporary pedestal and (ii) at least one optical interface. In some embodiments, the temporary pedestal may be the same as or similar to temporary pedestal 254 (and variants thereof) shown and described with reference to FIG. 2B.

Next, method 500 proceeds to block 504, which includes connecting each temporary pedestal to a dedicated port of an optical hub via one fiber of a multi-fiber cable. In some embodiments, connecting each temporary pedestal to a dedicated port of an optical hub via one fiber of a multi-fiber cable comprises, for one temporary pedestal at one subscriber pedestal termination point: (i) connecting the at least one optical interface of the one temporary pedestal to a dedicated optical fiber at least partially enclosed within a structurally-reinforced temporary multi-fiber cable running over ground from the temporary pedestal to the optical hub. In operation, the structurally-reinforced multi-fiber cable may be the same as or similar to the structurally-reinforced cable 258 (comprising dedicated fibers 258a, 258b, and 258c) or structurally-reinforced cable 300 shown and described with reference to FIGS. 2B and 3, respectively.

Next, method 500 proceeds to block 506, which includes, at each subscriber pedestal termination point, (i) disconnecting one or more subscriber coaxial drop cables from an existing pedestal, and (ii) connecting the one or more subscriber coaxial drop cables to the coaxial cable interface of the temporary pedestal, thereby enabling communication between the one or more subscriber coaxial drop cables and the optical hub over a single, dedicated optical fiber within the multi-fiber cable between the temporary pedestal and the optical hub. In operation, after connecting the plurality of temporary pedestals to the optical hub via the multi-fiber cable, each of the temporary pedestals of the plurality of temporary pedestals is configured to communicate with the optical hub over a separate, dedicated optical fiber at least partially enclosed within the multi-fiber cable. In some embodiments, the network configuration after connecting the plurality of temporary pedestals to the optical hub is the same as or similar to the network configuration of the temporary network shown and described with reference to FIG. 2B.

Then, method 500 proceeds to block 508, which includes, at each subscriber pedestal termination point of the plurality of subscriber pedestal termination points, and while the one or more subscriber coaxial drop cables are in communication with the optical hub via the temporary pedestal and the multi-fiber cable, (i) installing new pedestal hardware, (ii) connecting the new pedestal hardware to a new dedicated optical fiber connection to the optical hub, (iii) disconnecting the one or more subscriber coaxial drop cables from the temporary pedestal, and (iv) connecting the one or more subscriber coaxial drop cables to the new pedestal hardware, thereby enabling communication between the one or more subscriber coaxial drop cables and the optical hub over the new dedicated optical fiber connection via the new pedestal hardware.

While various aspects have been disclosed herein, other aspects will be apparent to those of skill in the art. The various aspects disclosed herein are for purposes of illustration only and are not intended to be limiting, with the true scope being indicated by the following claims, along with the full scope of equivalents to which such claims are entitled. It is also to be understood that the terminology used herein is for the purpose of describing particular example embodiments only, and is not intended to be limiting. For example, while the disclosed example embodiments focus on replacing coaxial cable with fiber cable, the disclosed systems and methods may be equally applicable to other upgrade scenarios, such as upgrading an old fiber optical cable infrastructure to a new fiber optic cable infrastructure.

What is claimed is:

1. A method of upgrading at least a portion of a hybrid fiber coax (HFC) network, wherein the method comprises:
deploying a plurality of portable, powered, temporary pedestals comprising one temporary pedestal at each of a plurality of subscriber pedestal termination points of the HFC network, wherein the temporary pedestal at each subscriber pedestal termination point comprises (i) a coaxial cable interface configured to connect one or more subscribers served by the subscriber pedestal termination point to the temporary pedestal, (ii) a first optical fiber interface, and (ii) a second optical fiber interface;
connecting the plurality of temporary pedestals into a daisy chain configuration;
communicatively coupling the daisy chain configuration of temporary pedestals to an optical hub; and
at each subscriber pedestal termination point, (i) disconnecting one or more subscriber coaxial drop cables from an existing pedestal, and (ii) connecting the one or more subscriber coaxial drop cables to the coaxial cable interface of the temporary pedestal, thereby enabling communication between the subscribers served by the subscriber pedestal termination point and upstream network infrastructure via the optical hub connected to the temporary pedestal over a single, shared temporary optical fiber connection.

2. The method of claim 1, further comprising:
at each subscriber pedestal termination point of the plurality of subscriber pedestal termination points, and while the subscribers served by the subscriber pedestal termination point are in communication with the upstream network infrastructure via the optical hub connected to the temporary pedestal over the single, shared temporary optical fiber connection, (i) installing new pedestal hardware (ii) connecting the new pedestal hardware to a new dedicated optical fiber connection to the optical hub, (iii) disconnecting the one or more subscriber coaxial drop cables from the temporary pedestal, and (iv) connecting the one or more subscriber coaxial drop cables to the new pedestal hardware, thereby enabling communication between the subscribers served by the subscriber pedestal termination point and the upstream network infrastructure via the optical hub connected to the new pedestal hardware over the new dedicated optical fiber connection.

3. The method of claim 2, wherein the portable, powered, temporary pedestal at each subscriber pedestal termination point comprises:
one or more batteries; and
an Optical Network Unit (ONU) configured to (i) receive downstream optical signals from the optical hub, (ii) convert the downstream optical signals into downstream electrical signals, (iii) transmit the downstream electrical signals to one or more subscribers served by the subscriber pedestal termination point; (iv) receive upstream electrical signals from one or more subscribers served by the subscriber pedestal termination point; (v) convert the upstream electrical signals to upstream optical signals;
and (vi) transmit the upstream optical signals to the optical hub.

4. The method of claim 2, wherein the portable, powered, temporary pedestal at each subscriber termination point comprises:
one or more batteries;
a Radio Frequency (RF) over Glass Optical Network Unit (RFoG ONU) comprising (i) an RFoG ONU optical port and (ii) an RFoG ONU coaxial cable port connected to the coaxial cable interface of the temporary pedestal; and
an optical splitter/coupler comprising (i) a first optical port connected to the first optical fiber interface of the temporary pedestal, (ii) a second optical port connected to the second optical fiber interface of the temporary pedestal, and (iii) a third optical port connected to the RFoG ONU optical port; and
wherein the temporary pedestal is configured to operate in a bidirectional fashion, wherein downstream transmissions from the optical hub to the subscriber pedestal termination point are carried on a downstream optical wavelength, and wherein upstream transmissions from the subscriber pedestal termination point to the optical hub are carried on an upstream optical wavelength that is different than the downstream optical wavelength.

5. The method of claim 4, wherein the optical splitter/coupler of the temporary pedestal at each subscriber pedestal termination point is configured to (i) pass approximately 5% of a downstream optical wavelength's signal power to the third optical port connected to the RFoG ONU optical port, (ii) pass approximately 95% of the downstream optical wavelength's signal power to the second optical port connected to the second optical fiber interface of the temporary pedestal, and (iii) couple optical signals from the second optical port and the third optical port to the first optical port.

6. The method of claim 5, wherein the RFoG ONU of the temporary pedestal at each subscriber pedestal termination point comprises:
an optical filter configured to separate one or more downstream optical wavelengths from other optical wavelengths received at the RFoG ONU optical port;
an optical-to-electrical converter configured to convert optical signals on the one or more downstream optical wavelengths to electrical signals that are output from the RFoG ONU coaxial cable port; and
an electrical-to-optical converter configured to convert electrical signals received at the RFoG ONU coaxial cable port to optical signals output from the RFoG ONU optical port.

7. The method of claim 6, wherein connecting the plurality of temporary pedestals into the daisy chain configuration comprises, for one temporary pedestal at one subscriber pedestal termination point:
connecting the first optical fiber interface of the one temporary pedestal to a first structurally-reinforced temporary optical cable running over ground between the one subscriber pedestal termination point and a first adjacent subscriber pedestal termination point; and
connecting the second optical fiber interface of the one temporary pedestal to a second structurally-reinforced temporary optical cable running over ground between the one subscriber pedestal termination point and a second adjacent subscriber pedestal termination point.

8. The method of claim 7, wherein after connecting the plurality of temporary pedestals into a daisy chain configuration and communicatively coupling the daisy chain configuration of temporary pedestals to the optical hub, all of the temporary pedestals of the plurality of temporary pedestals are configured to communicate with the optical hub over a single, shared optical fiber.

9. A portable, powered, temporary pedestal comprising:
a first optical fiber interface;
a second optical fiber interface;
a coaxial cable interface;
an Optical Network Unit (ONU) comprising (i) an ONU optical port and (ii) an ONU coaxial cable port connected to the coaxial cable interface of the temporary pedestal; and
an optical splitter/coupler comprising (i) a first optical port connected to the first optical fiber interface of the temporary pedestal, (ii) a second optical port connected to the second optical fiber interface of the temporary pedestal, and (iii) a third optical port connected to the ONU optical port; and
wherein the temporary pedestal is configured to operate in a bidirectional fashion, wherein downstream transmissions from an optical hub to the temporary pedestal are carried on a downstream optical wavelength, and wherein upstream transmissions from the temporary pedestal to the optical hub are carried on an upstream optical wavelength that is different than the downstream optical wavelength.

10. The portable, powered, temporary pedestal of claim 9, wherein the ONU is an RF over Glass (RFoG) ONU.

11. The portable, powered, temporary pedestal of claim 9, wherein the optical splitter/coupler of the temporary pedestal is configured to (i) pass approximately 5% of a downstream optical wavelength's signal power to the third optical port connected to the ONU optical port, (ii) pass approximately 95% of the downstream optical wavelength's signal power to the second optical port connected to the second optical fiber interface of the temporary pedestal, and (iii) couple optical signals from the second optical port and the third optical port to the first optical port.

12. The portable, powered, temporary pedestal of claim 9, wherein the ONU of the temporary pedestal at each subscriber pedestal termination point comprises:
an optical filter configured to separate the downstream optical wavelength from any other optical wavelengths received at the ONU optical port;
an optical-to-electrical converter configured to convert optical signals on the downstream optical wavelength to electrical signals that are output from the ONU coaxial cable port; and
an electrical-to-optical converter configured to convert electrical signals received at the ONU coaxial cable port to optical signals output from the ONU optical port.

13. A method of upgrading at least a portion of a hybrid fiber coax (HFC) network, wherein the method comprises:
deploying a plurality of portable, powered, temporary pedestals comprising one temporary pedestal at each of a plurality of subscriber pedestal termination points of the HFC network, wherein the temporary pedestal at each subscriber pedestal termination point comprises (i) a coaxial cable interface configured to connect one or more subscribers served by the subscriber pedestal terminal point to the temporary pedestal, and (ii) at least one optical fiber interface;
communicatively coupling each temporary pedestal to a dedicated port of an optical hub via a separate fiber of a temporary multi-fiber cable; and
after communicatively coupling each temporary pedestal to a dedicated port of the optical hub via a separate fiber of the temporary multi-fiber cable, at each subscriber pedestal termination point, (i) disconnecting one or more subscriber coaxial drop cables from an existing pedestal, and (ii) connecting the one or more subscriber coaxial drop cables to the coaxial cable interface of the temporary pedestal, thereby enabling communication between the subscribers served by the subscriber pedestal termination point and upstream network infrastructure via the optical hub connected to the temporary pedestal over a separate fiber of the temporary multi-fiber cable.

14. The method of claim 13, further comprising:
at each subscriber pedestal termination point of the plurality of subscriber pedestal termination points, and while the subscribers served by the subscriber pedestal termination point are in communication with the upstream network infrastructure via the optical hub connected to the temporary pedestal over the separate fiber of the temporary multi-fiber cable, (i) installing new pedestal hardware (ii) connecting the new pedestal hardware to a new dedicated optical fiber connection to the optical hub, (iii) disconnecting the one or more subscriber coaxial drop cables from the temporary pedestal, and (iv) connecting the one or more subscriber coaxial drop cables to the new pedestal hardware, thereby enabling communication between the subscribers served by the subscriber pedestal termination point and upstream network infrastructure via the optical hub connected to the new pedestal hardware over the new dedicated optical fiber connection.

15. The method of claim 14, wherein the portable, powered, temporary pedestal at each subscriber pedestal termination point comprises:
one or more batteries; and
an Optical Network Unit (ONU) configured to (i) receive downstream optical signals from the optical hub, (ii) convert the downstream optical signals into downstream electrical signals, (iii) transmit the downstream electrical signals to one or more subscribers served by the subscriber pedestal termination point; (iv) receive upstream electrical signals from one or more subscribers served by the subscriber pedestal termination point; (v) convert the upstream electrical signals to upstream optical signals; and (vi) transmit the upstream optical signals to the optical hub.

16. The method of claim 14, wherein the portable, powered, temporary pedestal at each subscriber pedestal termination point comprises:
one or more batteries;
a Radio Frequency (RF) over Glass Optical Network Unit (RFoG ONU) comprising (i) an RFoG ONU optical port and (ii) an RFoG ONU coaxial cable port connected to the coaxial cable interface of the temporary pedestal; and
wherein the temporary pedestal is configured to operate in a bidirectional fashion, wherein downstream transmissions from the optical hub to the subscriber pedestal termination point are carried on a downstream optical wavelength, and wherein upstream transmissions from the subscriber pedestal termination point to the optical hub are carried on an upstream optical wavelength that is different than the downstream optical wavelength.

17. The method of claim 16, wherein the RFoG ONU of the temporary pedestal at each subscriber pedestal termination point comprises:
an optical filter configured to separate the downstream optical wavelength from any other optical wavelengths received at the RFoG ONU optical port;
an optical-to-electrical converter configured to convert optical signals on the downstream optical wavelength to electrical signals that are output from the RFoG ONU coaxial cable port; and
an electrical-to-optical converter configured to convert electrical signals received at the RFoG ONU coaxial cable port to optical signals output from the RFoG ONU optical port.

18. The method of claim 17, wherein communicatively coupling each temporary pedestal to a dedicated port of an optical hub via a separate fiber of a temporary multi-fiber cable comprises, for one temporary pedestal at one subscriber pedestal termination point:
connecting the at least one optical fiber interface of the temporary pedestal to a first end of a dedicated fiber enclosed at least partially within a structurally-reinforced multi-fiber cable; and
connecting a second end of the dedicated fiber to a corresponding dedicated port of the optical hub.

19. The method of claim 18, wherein after connecting the plurality of temporary pedestals to the optical hub via the structurally-reinforced multi-fiber cable, each of the temporary pedestals of the plurality of temporary pedestals is connected to the optical hub via a separate, dedicated fiber enclosed at least partially within the temporary multi-fiber cable.

20. A portable, powered, temporary pedestal comprising:
at least one optical fiber interface;
a coaxial cable interface;
an Optical Network Unit (ONU) comprising (i) an ONU optical port connected to the at least one optical fiber interface and (ii) an ONU coaxial cable port connected to the coaxial cable interface; and
wherein the temporary pedestal is configured to operate in a bidirectional fashion, wherein downstream transmissions from an optical hub to the temporary pedestal are carried on a downstream optical wavelength, and wherein upstream transmissions from the temporary pedestal to the optical hub are carried on an upstream optical wavelength that is different than the downstream optical wavelength.

21. The portable, powered, temporary pedestal of claim 20, wherein the ONU is an RF over Glass (RFoG) ONU.

22. The portable, powered, temporary pedestal of claim 20, wherein the RFoG ONU of the temporary pedestal at each subscriber pedestal termination point comprises:
an optical filter configured to separate one or more downstream optical wavelengths from other optical wavelengths received at the ONU optical port;
an optical-to-electrical converter configured to convert optical signals on the one or more downstream optical wavelengths to electrical signals that are output from the ONU coaxial cable port; and
an electrical-to-optical converter configured to convert electrical signals received at the ONU coaxial cable port to optical signals output from the ONU optical port.
